(19) United States
(12) Patent Application Publication
(10) Pub. No.: US 2007/0154865 A1
(43) Pub. Date: Jul. 5, 2007

(54) Method of making digital plaster mold

(75) Inventors: Hong-Tzong Yau, Chiayi County (TW); Chuan-Chu Kuo, Chiayi County (TW); Yin-Shih Lu, Taichung City (TW); Chine-An Chen, Kaohsiung County (TW); Tai-Jen Chen, Tainan City (TW); Bin-Ru Tseng, Taipei County (TW)

Correspondence Address: BACON & THOMAS, PLLC, 625 SLATERS LANE, FOURTH FLOOR, ALEXANDRIA, VA, 22314, US

(73) Assignee: POU YUEN TECHNOLOGY CO., LTD., CHANG HWA HSIEN (TW)

(21) Appl. No.: 11/490,114

(22) Filed: Jul. 21, 2006

(30) Foreign Application Priority Data
Dec. 29, 2005 (TW) 94147335

(51) Int. Cl. A61C 11/00

(52) U.S. Cl. 433/213

(57) ABSTRACT

A method includes the steps of preparing a tooth mold of a rollover from a patient's mouse; scanning the tooth mold to convert it into digital data and to create a digital model; conducting operations of at least positioning, integration, and edition of the digital model to create a digital plaster mold; and converting the digital plaster mold through computer-added manufacturing (CAM) into a program for a processing machine and then processing a material with the processing machine based on the program to produce a substantial plaster mold. Accordingly, the present invention can simplify the delivery/transportation process, reduce the costs, speed up the production, and do the standardization.

### BACKGROUND OF THE INVENTION

1. Field of the Invention

The present invention relates generally to tooth molding technology, and more particularly, to a method of making a digital plaster mold.

2. Description of the Related Art

The production of a tooth mold has been gradually developed as international OEM (original equipment manufacture) mode and its delivery time has been the key factor that most of customers care while ordering the tooth molds. The delivery time is averagely 14 days currently. Since the substantial plaster molds are required to be bases and criteria for producing tooth molds in the actual operation, the process of two-way delivery of the prototype and finished products is required. For example, while the destination is USA, the two-way delivery costs 7 days in transportation; however, excluding the time of switching and confirmation, there are merely 3 or 4 days left for the actual production. Thus, the whole production is relatively urgent in time.

In addition, during the transportation of the plaster molds, the plaster molds are vulnerable to portage and other environmental factors to cause difference of criteria between manufacturers and their clients to further incur loss of orders and business. Further, the plaster molds are not digitized data, thus failing to take good use of Internet interface for real-time communication to overcome the problems of production and making it more difficult to enhance the smoothness and the equality of manufacturing process.

The transportation process also results in additional costs of transaction and management of the products for the suppliers, e.g. tracing of and contact with delivery units (express) and relevant administrative personnel, thus increasing more administrative and operational costs.

### SUMMARY OF THE INVENTION

The primary objective of the present invention is to provide a method of making a digital plaster mold, which simplifies the delivery/transoprtation process to speed up the delivery and to avoid damage to the cargo.

The secondary objective of the present invention is to provide a method of making a digital plaster mold, which enables the manufacturer and its client to have uniform criterion and to avoid inconsistent quality.

The foregoing objectives of the present invention are attained by the method including the steps of preparing a tooth mold of a rollover from a patient's mouse; scanning the tooth mold to convert it into digital data and to create a digital model; conducting operations of at least positioning, integration, and edition of the digital model to create a digital plaster mold; and converting the digital plaster mold through computer-added manufacturing (CAM) into a program for a processing machine and then processing a material with the processing machine based on the program to produce a substantial plaster mold. Accordingly, the present invention can simplify the delivery/transportation process, reduce the costs, speed up the production, and do the standardization.

### BRIEF DESCRIPTION OF THE DRAWINGS

FIG. 1 is a block diagram of a preferred embodiment of the present invention, showing the schematic steps.

FIG. 2 is a block diagram of a preferred embodiment of the present invention, showing the detailed steps.

FIG. 3 is similar to FIG. 1, but showing one more step than FIG. 1.

### DETAILED DESCRIPTION OF PREFERRED EMBODIMENTS

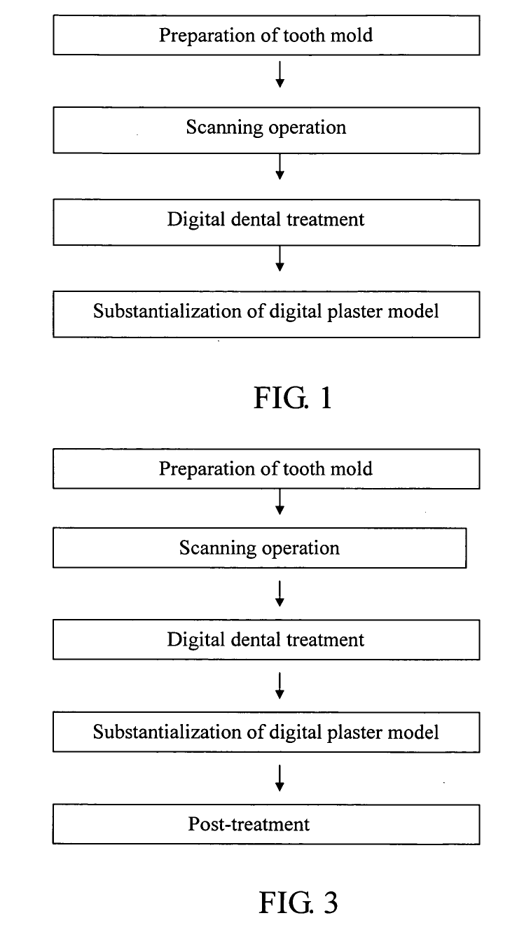

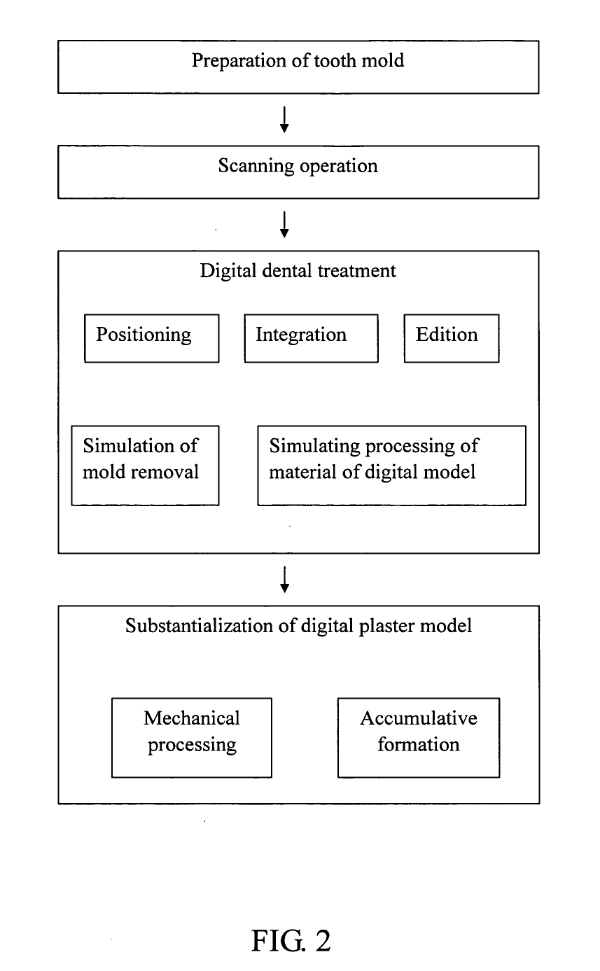

Referring to FIGS. 1 and 2, a method of making a digital plaster mold, according to a preferred embodiment of the present invention includes the following steps.
(A) Preparation of a tooth mold: Prepare a tooth mold of a rollover from a patient's mouse, wherein the tooth mold can be made of plaster, wax, or other material.
(B) Scanning operation: Scan the tooth mold and convert it into digital data to create a digital model, wherein the digital model includes the patient's arrangement of teeth, location of gums, type of abutment teeth, and dental occlusion.
(C) Digital dental treatment: Conduct operations of at least positioning, integration, and edition of the digital model to create a digital plaster mold, wherein while the operation of positioning is conducted, the digital model is aligned with a predetermined angle and position to facilitate the following operation of edition; while the operation of integration is conducted, some repetitive and inaccurate data are eliminated for each single tooth in the digital model and the remaining correct data are integrated for prepositional data of the digital plaster mold; while the operation of edition is conducted, the edge line of the digital model is employed to locate the gums line. Alternatively, this step can further include an operation of simulating mold removal of a material of the digital model after the operation of edition, in which the digital model is applied with a simulated process of mold removal to confirm the finished article and its dental occlusion. Alternatively, this step can further includes an operation of simulating processing of a material of the digital model, in which computer-aided design (CAD) is employed to simulate the interrelationship of the material with the cutter and jig during the processing process to avoid the problems incurred during the real processing process.
(D) Substantialization of the digital plaster model: Input the digital plaster mold into a processing machine and process a material with the processing machine to produce a substantial plaster mold, wherein the processing manner can be mechanical processing or accumulative formation. While the mechanical process is conducted, an electronic processing file, i.e. an electronic file that the digital plaster mold is inputted into the processing machine, is imported to a CAM programming software for production and output and converted into mechanical note change (NC) code to process the substantial material to output a finished product of substantial plaster mold. While the accumulative formation is conducted, the substantial plaster mold is produced by laminated accumulation of the material adhesively or through the irradiation of the light according to an electronic three-dimensional (3D) file of the digital plaster mold file.

As indicated above, after the rollover of the patient's mouse, the substantial tooth mold is formed and then scanned into a digital model, and finally the digital plaster mold is produced. Such digital plaster mold is digital data which can be transmitted through Internet or directly converted to an electronic file to be saved into a portable storage device for portable convenience. After the digital data is transmitted to a destination, the local manufacturer of the destination can employ the file for processing and production to produce the substantial plaster mold locally. The aforesaid electronic transmission has advantages of speed and integrity to improve the prior art.

In addition to the above-mentioned steps, as shown in FIG. 3, the present invention can further include a step (E): Conduct assembly and restructure of the finished substantial plaster mold to enable it to match the patient's mouse more precisely.

In conclusion, the present invention can improve the drawbacks of long delivery time, high delivery cost, and damage incurred during the delivery for the prior art. Further, the electronic transmission can facilitate the standardization to unify the standards held by the manufacturer and its customer, further minimizing the inaccuracy and even reaching zero error.

Although the present invention has been described with respect to a specific preferred embodiment thereof, it is no way limited to the details of the illustrated structures but changes and modifications may be made within the scope of the appended claims.

What is claimed is:

1. A method of making a digital plaster mold, comprising steps of:
(A) preparing a tooth mold of a rollover from a patient's mouse;
(B) scanning said tooth mold to convert it into digital data to further generate a digital model;
(C) conducting operations of at least positioning, integration, and edition of said digital model to generate a digital plaster mold; and
(D) converting said digital plaster mold through computer-aided manufacturing (CAM) into a program for a processing machine and processing a material to produce a substantial plaster mold.

2. The method as defined in claim 1, wherein in the step (A), said tooth mold is made of plaster or wax or other material.

3. The method as defined in claim 1, wherein in the step (B), said digital model includes at least arrangement of teeth, location of gums, type of abutment teeth, and dental occlusion.

4. The method as defined in claim 1, wherein in the step (C), while the operation of positioning is conducted, said digital model is positioned to align itself with a predetermined angle and position to facilitate the following operation of edition.

5. The method as defined in claim 1, wherein in the step (C), while the operation of integration is conducted, some repetitive and inaccurate digital data are eliminated for each single tooth in said digital model and then the remaining correct digital data are integrated into prepositional data of said digital plaster mold.

6. The method as defined in claim 1, wherein in the step (C), while the operation of edition is conducted, an edge line of said digital model is employed to locate a gums line.

7. The method as defined in claim 1, wherein said the step (C) further includes an operation of simulating mold removal of said digital model after the operations of integration and edition.

8. The method as defined in claim 7, wherein the step (C) further includes an operation of simulating interrelationship of a material with a cutter and a jig during a processing by means of computer-aided design (CAD).

9. The method as defined in claim 1, wherein in the step (D), the material is applied with mechanical processing thereto or accumulative formation thereto.

10. The method as defined in claim 1 further includes a step (E) of conducting assembly and restructure of said substantial plaster mold to enable said substantial plaster mold to match the patient's mouse more precisely.
